(19) United States
(12) Patent Application Publication
(10) Pub. No.: US 2020/0072625 A1
(43) Pub. Date: Mar. 5, 2020

(54) INFORMATION PROCESSING DEVICE, INFORMATION PROCESSING METHOD, AND RECORDING MEDIUM

(71) Applicant: TOYOTA JIDOSHA KABUSHIKI KAISHA, Toyota-shi (JP)

(72) Inventors: Koichi SUZUKI, Miyoshi-shi (JP); Makoto AKAHANE, Nagoya-shi (JP)

(73) Assignee: TOYOTA JIDOSHA KABUSHIKI KAISHA, Toyota-shi (JP)

(21) Appl. No.: 16/521,847

(22) Filed: Jul. 25, 2019

(30) Foreign Application Priority Data
Sep. 4, 2018 (JP) 2018-165475

(51) Int. Cl. G01C 21/34; G01C 21/36; G06K 9/00; G06K 9/20; G06Q 10/02

(52) U.S. Cl. CPC G01C 21/3461; G01C 21/3476; G06Q 10/025; G06K 9/00677; G06K 9/20; G01C 21/3623

(57) ABSTRACT

In an information processing device, a first acquirer acquires an image capture position of a captured image. A second acquirer acquires, from a user, plan information including a scheduled visiting place. A relating unit relates, when the image capture position of the captured image is present within or near the scheduled visiting place, the captured image to the plan information for the scheduled visiting place.

The disclosure of Japanese Patent Application No. 2018-165475 filed on Sep. 4, 2018 including the specification, drawings and abstract is incorporated herein by reference in its entirety.

### BACKGROUND

### 1. Technical Field

The present disclosure relates to a technology for organizing captured images.

### 2. Description of Related Art

There have been requests for automatic organizing of multiple images captured by smartphones or the like. WO 2016/031431 discloses an information processing device that acquires a period from the start to the end of a plan registered in a plan sharing application, acquires, after the period of the plan has elapsed, image data captured during the period, and creates a slide show using the acquired image data.

In the technology of WO 2016/031431, however, if the user stays at the place of the plan after the period of the plan has elapsed, image data captured at the place after the period of the plan has elapsed will not be acquired. Also, if the user moves to another place before the period of the plan elapses, image data captured at the another place will also be acquired without being distinguished from the image data captured at the place of the plan. Thus, with the technology of WO 2016/031431, if the user does not move as scheduled, acquiring appropriate image data will be difficult.

### SUMMARY

The present embodiment addresses the above-described issue, and a general purpose thereof is to provide an information processing device, an information processing method, and a recording medium for relating a captured image to a plan more accurately even when a user does not move as scheduled.

In response to the above issue, an information processing device of one aspect of the present embodiment includes: a first acquirer configured to acquire an image capture position of a captured image; a second acquirer configured to acquire, from a user, plan information including a scheduled visiting place; and a relating unit configured to relate, when the image capture position of the captured image is present within or near the scheduled visiting place, the captured image to the plan information for the scheduled visiting place.

According to this aspect, when the image capture position of a captured image is present within or near a scheduled visiting place, the captured image is related to the plan information for the scheduled visiting place. Therefore, even when a user does not move as scheduled, a captured image can be related to a plan more accurately.

The first acquirer may acquire an image capture date and time of the captured image, and the plan information may include a period of stay at the scheduled visiting place. Also, when the image capture position of the captured image is present within or near the scheduled visiting place and when the image capture date and time of the captured image and the period of stay at the scheduled visiting place satisfy a predetermined relation, the relating unit may relate the captured image to the plan information for the scheduled visiting place.

The information processing device may further include a third acquirer configured to acquire travelling schedule information including a traveling route from a departure point to the scheduled visiting place. Also, when the image capture position of the captured image is present on or near the traveling route, the relating unit may relate the captured image to the travelling schedule information for the traveling route.

Another aspect of the present embodiment relates to an information processing method. The information processing method includes: acquiring an image capture position of a captured image; acquiring, from a user, plan information including a scheduled visiting place; and relating, when the image capture position of the captured image is present within or near the scheduled visiting place, the captured image to the plan information for the scheduled visiting place.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram that shows a configuration of an information processing system according to an embodiment;

FIG. 2 is a block diagram that shows a configuration of a terminal device shown in FIG. 1;

FIG. 3 is a block diagram that shows a configuration of a server device shown in FIG. 1;

FIG. 4 is a diagram that shows an example of a schedule screen displayed on a display unit of the terminal device shown in FIG. 2; and

FIG. 5 is a flowchart that shows relating processing for a captured image performed in the server device shown in FIG. 1.

### DETAILED DESCRIPTION

Various embodiments now will be described. The embodiments are illustrative and are not intended to be limiting.

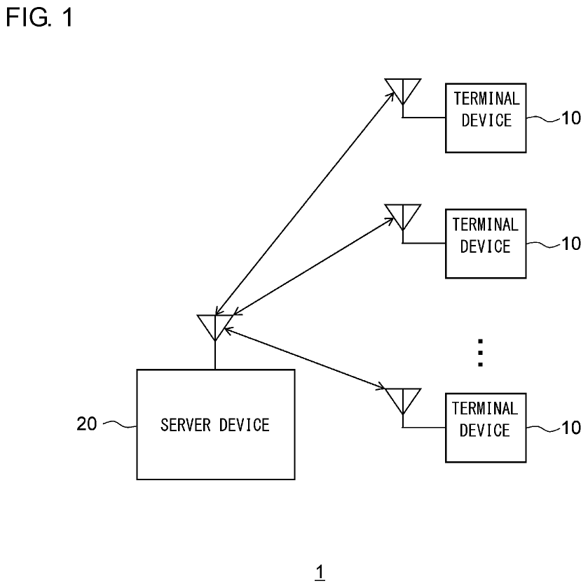

FIG. 1 is a block diagram that shows a configuration of an information processing system 1 according to an embodiment. The information processing system 1 may also be referred to as a schedule management system for managing a schedule of a user and organizing images captured by the user, based on the schedule. The information processing system 1 includes multiple terminal devices 10 respectively used by different users, and a server device 20.

Each terminal device 10 may be a portable device, such as a smartphone, cellular phone, and tablet terminal, carried by a user and has an image capturing function. Each terminal device 10 performs wireless communication with the server device 20. The wireless communication standard is not particularly limited, and may be 3G (third-generation mobile communication system), 4G (fourth-generation mobile communication system), or 5G (fifth-generation mobile communication system), for example. Each terminal device 10 10 may perform wireless communication with the server device 20 via a base station, which is not illustrated. The server device 20 may be installed in a data center, for example, and functions as an information processing device for processing information transmitted from the terminal devices 10.

In the embodiment, when a user registers plan information, such as a scheduled visiting place, in the server device 20 via a terminal device 10 and when the terminal device 10 captures an image thereafter, the server device 20 relates the captured image to plan information that includes a scheduled visiting place corresponding to the image capture position of the captured image. In the following, “1. Registration Processing for Plan Information” and “2. Relating Processing for Captured Image” will be described in this order.

### 1. Registration Processing for Plan Information

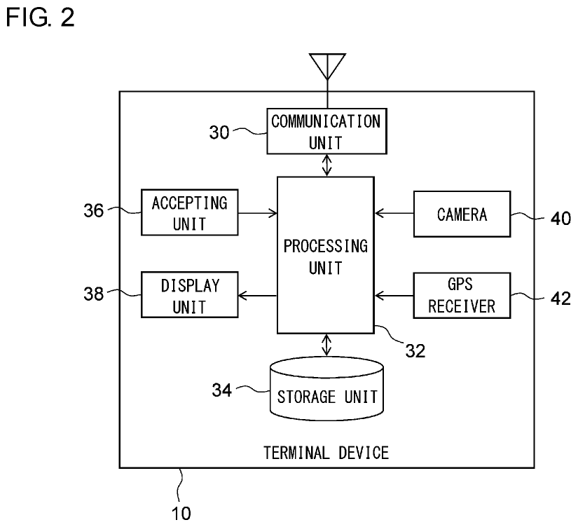

FIG. 2 is a block diagram that shows a configuration of a terminal device 10 shown in FIG. 1. Each terminal device 10 includes a communication unit 30, a processing unit 32, a storage unit 34, an accepting unit 36, a display unit 38, a camera 40, and a GPS receiver 42. The accepting unit 36 accepts multiple entries of plan information from a user. The plan information includes a scheduled plan, a scheduled visiting place, and a period of stay at the scheduled visiting place. The start point of the period of stay at the scheduled visiting place is the scheduled date and time of the plan, and the end point of the period of stay is the finish date and time of the plan. It is assumed that the user enters such information on a schedule screen displayed on the display unit 38. The accepting unit 36 outputs the plan information to the processing unit 32 and stores the plan information in the storage unit 34.

For example, if the user enters “ABC University” in characters as a scheduled visiting place into the terminal device 10, the terminal device 10 may display multiple scheduled visiting place candidates, such as “X1 Campus in ABC University” and “X2 Campus in ABC University”, to identify the scheduled visiting place, and the user may select the scheduled visiting place from among the candidates. Alternatively, the scheduled visiting place may be specified on a displayed map.

The processing unit 32 transmits the plan information thus entered, to the server device 20 via the communication unit 30. To the plan information to be transmitted, information for identifying the user (hereinafter, referred to as user identification information), such as a user ID, is attached.

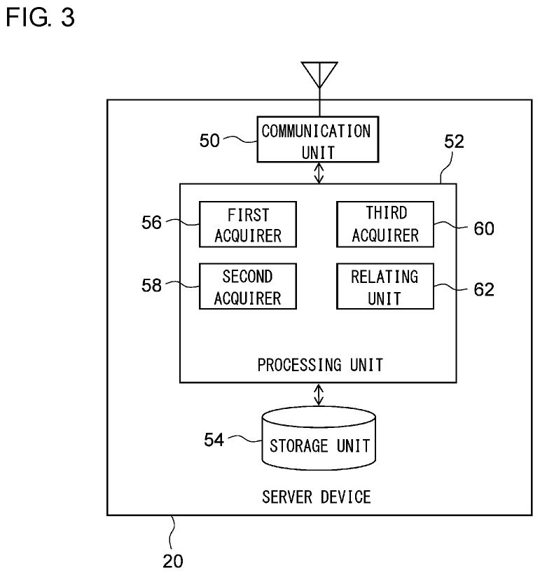

FIG. 3 is a block diagram that shows a configuration of the server device 20 shown in FIG. 1. The server device 20 includes a communication unit 50, a processing unit 52, and a storage unit 54. The processing unit 52 includes a first acquirer 56, a second acquirer 58, a third acquirer 60, and a relating unit 62.

The configuration of the processing unit 52 may be implemented by a CPU or memory of any given computer, an LSI, or the like in terms of hardware, and by a memory-loaded program or the like in terms of software. In the present embodiment is shown a functional block configuration realized by cooperation thereof. Therefore, it would be understood by those skilled in the art that these functional blocks may be implemented in a variety of forms by hardware only, software only, or a combination thereof.

The communication unit 50 performs wireless communication with each terminal device 10. The communication unit 50 receives plan information from each terminal device 10. The communication unit 50 then outputs the plan information to the second acquirer 58.

The second acquirer 58 acquires the plan information received at the communication unit 50. This corresponds to acquiring, by the second acquirer 58, the plan information from the user. The second acquirer 58 then outputs the plan information thus acquired to the third acquirer 60 and also stores the plan information in the storage unit 54.

For each piece of plan information output from the second acquirer 58, the third acquirer 60 acquires travelling schedule information for enabling arrival at the scheduled visiting place by the scheduled date and time. More specifically, the third acquirer 60 determines transportation, a traveling period from the departure point to the scheduled visiting place, a traveling route from the departure point to the scheduled visiting place, and a fee required for the traveling so that the user can arrive at the scheduled visiting place by the scheduled date and time. The start point of the traveling period is an estimated departure date and time at the departure point, and the end point of the traveling period is an estimated arrival date and time at the scheduled visiting place. The transportation includes by car, train, bus, and foot, for example. For the plan information, the scheduled visiting place in the preceding plan information on the same day is regarded as the departure point, and the estimated departure date and time is set to the finish date and time in the preceding plan information or later. When there is no preceding plan information on the same day, the user's house as set in advance is regarded as the departure point. The third acquirer 60 also acquires the travelling schedule information required for the user to depart at the finish date and time in the last plan information of the day and arrive at the user's house. Instead of the user's house, a hotel or other accommodation may be specified.

The third acquirer 60 may determine the transportation, traveling route, and the like such that the traveling time becomes shortest, for example. For the determination of the estimated departure date and time and the like, well-known technologies can be employed. The third acquirer 60 acquires the transportation, traveling period, traveling route, and fee thus determined, as the travelling schedule information. The third acquirer 60 then stores the travelling schedule information thus acquired in the storage unit 54 and also outputs the travelling schedule information to the communication unit 50. The communication unit 50 transmits the travelling schedule information to a corresponding terminal device 10. To the information to be stored and transmitted, the user identification information is attached.

The description will now return to FIG. 2. In the terminal device 10, the communication unit 30 receives the travelling schedule information transmitted from the communication unit 50 and then outputs the travelling schedule information to the processing unit 32. Accordingly, the processing unit 32 displays, in the form of a schedule screen on the display unit 38, information regarding the travelling schedule information in addition to the information regarding plan information entered by the user, with characters and images.

The transportation thus displayed may be changed in response to operation input from the user accepted at the accepting unit 36. When the transportation is changed, the communication unit 30 of the terminal device 10 transmits information of the new transportation to the server device 20, the third acquirer 60 acquires new travelling schedule information based on the new transportation accordingly, and the new travelling schedule information thus acquired is displayed on the terminal device 10.

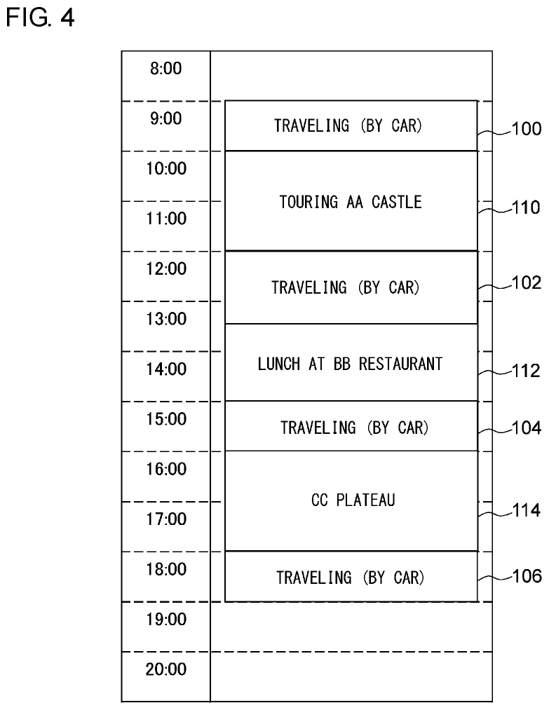

FIG. 4 shows an example of the schedule screen displayed on the display unit 38 of the terminal device 10 shown in FIG. 2. The schedule screen shows a daily schedule and includes information 100, 102, 104, 106 regarding travelling schedule information, and information 110, 112, 114 regarding plan information. These pieces of information are displayed along a time axis.

The information 100 regarding travelling schedule information has been transmitted from the server device 20 and shows that the estimated departure time at the user's house is 9:00, the estimated arrival time at “AA Castle” is 10:00, and the transportation is by car. In response to predetermined operation input, the traveling route and fee, currently not displayed, may also be displayed.

The information 110 regarding plan information has been entered by the user and shows that the scheduled time is 10:00, the finish time is 12:00, the scheduled visiting place is “AA Castle”, and the scheduled plan is “Touring AA Castle”.

The information 102 regarding travelling schedule information shows that the estimated departure time at “AA Castle” is 12:00, the estimated arrival time at “BB Restaurant” is 13:30, and the transportation is by car.

The information 112 regarding plan information shows that the scheduled time is 13:30, the finish time is 15:00, the scheduled visiting place is “BB Restaurant”, and the scheduled plan is “Lunch at BB Restaurant”.

The information 104 regarding travelling schedule information shows that the estimated departure time at “BB Restaurant” is 15:00, the estimated arrival time at “CC Plateau” is 16:00, and the transportation is by car.

The information 114 regarding plan information shows that the scheduled time is 16:00, the finish time is 18:00, and each of the scheduled visiting place and the scheduled plan is “CC Plateau”.

The information 106 regarding travelling schedule information shows that the estimated departure time at “CC Plateau” is 18:00, the estimated arrival time at the user's house is 19:00, and the transportation is by car.

### 2. Relating Processing for Captured Image

Description will be given with reference to FIGS. 2 and 3. In the terminal device 10, the camera 40 captures an image and outputs the captured image to the processing unit 32. Upon acquisition of the captured image from the camera 40, the processing unit 32 acquires the image capture date and time of the captured image and also acquires the image capture position of the captured image derived by the GPS receiver 42. The processing unit 32 then stores the captured image in the storage unit 34. The processing unit 32 does not embed the image capture position information in the captured image.

The processing unit 32 regularly transmits, to the server device 20 via the communication unit 30, image identification information for identifying a captured image, the image capture date and time of the captured image, and the image capture position of the captured image. These pieces of information regarding the same captured image are related to each other. The communication unit 30 may transmit these pieces of information each time a captured image is acquired. To the information to be transmitted, the user identification information is attached.

In the server device 20, the communication unit 50 receives the information transmitted from the terminal device 10 and then outputs the information thus received to the first acquirer 56.

The first acquirer 56 acquires the image identification information, the image capture position of the captured image, and the image capture date and time of the captured image, and outputs the information thus acquired to the relating unit 62. The first acquirer 56 also outputs the user identification information attached to the acquired information, to the second acquirer 58 and the third acquirer 60.

The second acquirer 58 acquires, from the storage unit 54, plan information associated with the user identification information output from the first acquirer 56 and outputs the plan information thus acquired to the relating unit 62.

The third acquirer 60 acquires, from the storage unit 54, travelling schedule information associated with the user identification information output from the first acquirer 56 and outputs the travelling schedule information thus acquired to the relating unit 62.

When the image capture position of a captured image is present within or near a scheduled visiting place in plan information and when the image capture date and time of the captured image and the period of stay at the scheduled visiting place satisfy a predetermined first relation, the relating unit 62 relates the captured image to the plan information for the scheduled visiting place. Relating the captured image to the plan information corresponds to relating the image identification information to the plan information. The relating unit 62 relates a captured image to plan information that includes a scheduled date and time or a finish date and time closest to the image capture date and time of the captured image. Thus, a captured image may be related to a piece of plan information.

When the image capture position of a captured image is not present within or near a scheduled visiting place, the relating unit 62 does not relate the captured image to the plan information for the scheduled visiting place. Also, when the image capture date and time of a captured image and the period of stay at a scheduled visiting place do not satisfy the predetermined first relation, the relating unit 62 does not relate the captured image to the plan information for the scheduled visiting place.

Being near a scheduled visiting place means being within a predetermined first distance from an area indicating the scheduled visiting place. The first distance may be appropriately determined through experiments or the like such that a captured image of a scheduled visiting place captured from outside the area indicating the scheduled visiting place is also related to the corresponding plan information. The first distance may be determined for each scheduled visiting place.

Satisfying the predetermined first relation means that the image capture date and time is included in the period of stay at the scheduled visiting place or that the image capture date and time and the scheduled date and time or the finish date and time of the period of stay at the scheduled visiting place are included in a predetermined period of time. The predetermined period of time may be around a week, for example, and can be appropriately determined through experiments or the like. The predetermined period of time may be determined by the user. Accordingly, even if the order of visiting multiple scheduled visiting places in a day is different from the registered visiting order, for example, a captured image can be related to the plan information for the corresponding scheduled visiting place. Meanwhile, even if a user's action is different from registered plan information, the plan information will not be changed.

When the image capture position of a captured image is present on or near a traveling route and when the image capture date and time of the captured image and the traveling period along the traveling route satisfy a predetermined second relation, the relating unit 62 relates the captured image to the travelling schedule information for the traveling route. The relating unit 62 relates a captured image to travelling schedule information that includes an estimated departure date and time or an estimated arrival date and time closest to the image capture date and time of the captured image. Thus, a captured image may be related to a piece of travelling schedule information. When a captured image has been related to plan information, the captured image is not related to travelling schedule information.

When the image capture position of a captured image is not present on or near a traveling route, the relating unit 62 does not relate the captured image to the travelling schedule information for the traveling route. Also, when the image capture date and time of a captured image and the traveling period along a traveling route do not satisfy the predetermined second relation, the relating unit 62 does not relate the captured image to the travelling schedule information for the traveling route.

Being near a traveling route means being within a predetermined second distance from the traveling route. The second distance may also be appropriately determined through experiments or the like. Satisfying the predetermined second relation means that the image capture date and time is included in the traveling period along the traveling route or that the image capture date and time and the estimated departure date and time or the estimated arrival date and time in the traveling period along the traveling route are included in a predetermined period of time.

The relating unit 62 outputs, to the communication unit 50, relation information between image identification information and plan information or travelling schedule information, and the communication unit 50 then transmits the relation information to a corresponding terminal device 10. To the relation information to be transmitted, the user identification information is attached.

In the terminal device 10, the communication unit 30 receives the relation information transmitted from the communication unit 50. Based on the received relation information, the processing unit 32 creates, for each piece of plan information, a folder that contains a captured image related to the plan information, and also creates, for each piece of travelling schedule information, a folder that contains a captured image related to the travelling schedule information. For a created folder, the date and the scheduled visiting place in the plan information, such as “August 20, AA Castle”, may be displayed. Also, for a created folder, the date and information regarding the traveling route in the travelling schedule information, such as “August 20, Landscape on Route XX”, may be displayed. The content of a created folder may be displayed using a file management application or the like.

When the accepting unit 36 accepts a user's selecting operation for plan information or travelling schedule information displayed on the schedule screen, the processing unit 32 displays, on the display unit 38, the content of a folder associated with the plan information or travelling schedule information for which the selecting operation has been accepted. Thus, content of a desired folder can be easily displayed based on plan information or the like on the schedule screen, thereby improving the convenience.

By executing a map application, the processing unit 32 can display, on a scheduled visiting place or a traveling route on the map, an icon indicating the presence of a captured image related to the scheduled visiting place or traveling route, based on the relation information. When the accepting unit 36 accepts a user's selecting operation for an icon, the processing unit 32 displays, on the display unit 38, the content of a folder associated with the icon for which the selecting operation has been accepted. Thus, content of a desired folder can be easily displayed based on an icon on the map, thereby improving the convenience.

Plan information and travelling schedule information may be shared with the terminal device 10 of another user who is going to travel together. In this case, when the accepting unit 36 accepts a user's operation for specifying another user, the processing unit 32 displays, on the display unit 38, the content of a folder that contains a captured image related to plan information and travelling schedule information shared with the another user. Thus, content of a folder associated with a desired user can be easily displayed, thereby improving the convenience.

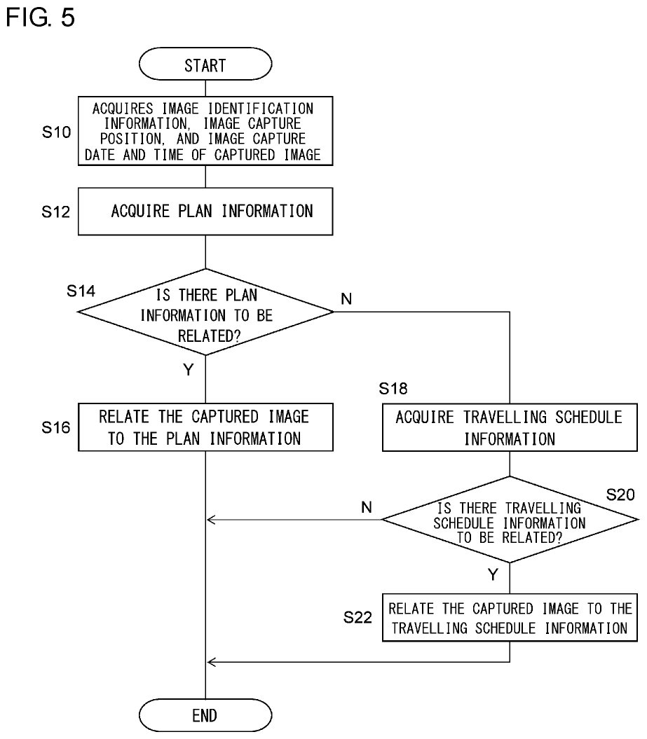

There will now be described the overall operation of the information processing system 1 having the configuration set forth above. FIG. 5 is a flowchart that shows relating processing for a captured image performed in the server device 20 shown in FIG. 1. The processing shown in FIG. 5 is performed each time the communication unit 50 receives image identification information or the like from a terminal device 10.

The first acquirer 56 acquires the image identification information, the image capture position, and the image capture date and time of a captured image (S10). The second acquirer 58 acquires plan information (S12). When there is plan information to be related (Y at S14), the relating unit 62 relates the captured image to the plan information (S16), and the processing is terminated.

When there is no plan information to be related (N at S14), the third acquirer 60 acquires travelling schedule information (S18). When there is travelling schedule information to be related (Y at S20), the relating unit 62 relates the captured image to the travelling schedule information (S22), and the processing is terminated. When there is no travelling schedule information to be related (N at S20), the processing is terminated.

According to the present embodiment, even when a user does not move as scheduled, such as when the user stays at a scheduled visiting place for a period different from the period of stay in the plan information, a captured image can be related to the plan more accurately. Also, a captured image captured during traveling can also be related to a travelling schedule. Thus, the user's convenience can be improved. Also, since the image capture position information is not embedded in captured image data, the image capture position cannot be easily identified by a third party who has acquired the captured image.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

For example, when the image capture position of a captured image is present within or near a scheduled visiting place, the relating unit 62 may relate the captured image to the plan information for the scheduled visiting place, without using the predetermined first relation. Also, when the image capture position of a captured image is present on or near a traveling route, the relating unit 62 may relate the captured image to the travelling schedule information for the traveling route, without using the predetermined second relation. This modification simplifies the processing.

In the embodiment, an example has been described in which, when the image capture date and time of a captured image and the period of stay at a scheduled visiting place do not satisfy the predetermined first relation, relating processing is not performed. However, in such a case, if the image capture position is present within or near the scheduled visiting place and if the period of stay at the scheduled visiting place is later than the image capture date and time, the relating unit 62 may perform provisional relating processing. For example, if there is plan information including “AA Castle” as the scheduled visiting place to visit after a month and if the user visits “AA Castle” beforehand for a preview and captures an image, the relating unit 62 may provisionally relate the captured image to the plan information for the scheduled visiting place “AA Castle”. Until the period of stay in the plan information elapses, the server device 20 will not transmit the provisional relation information to the terminal device 10; accordingly, a folder associated with the plan information will not be created on the terminal device 10, and the user will not find the provisional relating.

If the user visits “AA Castle” after a month as specified in the plan information, the relating unit 62 will delete the provisional relation information. This can prevent a captured image at the time and a captured image at the preview being stored in the same folder, so as to prevent the situation where the captured images cannot be easily distinguished from each other. Meanwhile, if the user does not visit “AA Castle” after a month, as changed from the plan information, it may be highly convenient if the captured image at the preview can be displayed based on the plan information. Accordingly, when the period of stay in the plan information for “AA Castle” has elapsed, the relating unit 62 may fix the provisional relation information as the relation information and transmit the relation information thus fixed to the terminal device 10. The terminal device 10 then creates, for the plan information, a folder that contains the captured image at the preview. Therefore, the folder can be displayed for the user after the period of stay in the plan information for “AA Castle” elapses. This modification further improves the user's convenience.

Although an example has been described in the embodiment in which the first acquirer 56, second acquirer 58, third acquirer 60, and relating unit 62 are provided in the server device 20, these may be provided in the processing unit 32 of a terminal device 10. In this case, the first acquirer 56 acquires image identification information or the like of a captured image, and the second acquirer 58 acquires plan information entered by the user. The server device 20 determines travelling schedule information. Also, the third acquirer 60 acquires travelling schedule information from the server device 20, and the relating unit 62 performs relating processing. In this case, the terminal device 10 functions as an information processing device. This modification can simplify the configuration of the server device 20 and allow greater flexibility in the configuration of the information processing system 1.

What is claimed is:

1. An information processing device, comprising:
a first acquirer configured to acquire an image capture position of a captured image;
a second acquirer configured to acquire, from a user, plan information including a scheduled visiting place; and
a relating unit configured to relate, when the image capture position of the captured image is present within or near the scheduled visiting place, the captured image to the plan information for the scheduled visiting place.

2. The information processing device of claim 1, wherein:
the first acquirer acquires an image capture date and time of the captured image;
the plan information includes a period of stay at the scheduled visiting place; and,
when the image capture position of the captured image is present within or near the scheduled visiting place and when the image capture date and time of the captured image and the period of stay at the scheduled visiting place satisfy a predetermined relation, the relating unit relates the captured image to the plan information for the scheduled visiting place.

3. The information processing device of claim 1, further comprising a third acquirer configured to acquire travelling schedule information including a traveling route from a departure point to the scheduled visiting place, wherein,
when the image capture position of the captured image is present on or near the traveling route, the relating unit relates the captured image to the travelling schedule information for the traveling route.

4. An information processing method, comprising:
acquiring an image capture position of a captured image;
acquiring, from a user, plan information including a scheduled visiting place; and
relating, when the image capture position of the captured image is present within or near the scheduled visiting place, the captured image to the plan information for the scheduled visiting place.

5. A non-transitory computer-readable recording medium encoded with a program comprising computer-implemented modules including:
a module that acquires an image capture position of a captured image;
a module that acquires, from a user, plan information including a scheduled visiting place; and
a module that relates, when the image capture position of the captured image is present within or near the scheduled visiting place, the captured image to the plan information for the scheduled visiting place.
